(19) United States
(12) Patent Application Publication
(10) Pub. No.: US 2026/0333206 A1
(43) Pub. Date: Oct. 22, 2026

(54) MONITORING EVENT (MONTE) SUBSCRIPTION REQUEST

(71) Applicant: T-Mobile USA, Inc., Bellevue, WA (US)

(72) Inventor: Zenaida Castro Canlas-Factora, Renton, WA (US)

(21) Appl. No.: 19/185,086

(22) Filed: Apr. 21, 2025

(51) Int. Cl. H04W 48/16; H04W 8/20; H04W 24/08

(52) U.S. Cl. CPC H04W 48/16; H04W 8/20; H04W 24/08

(57) ABSTRACT

Systems and methods for improving Monitoring Event (MONTE) subscription process are disclosed. A MONTE subscription allows users of a telecommunications network to receive information about a particular mobile device, such as location or roaming status. A MONTE subscription request can identify a mobile device and identify a Radio Access Technology (RAT) Type, such as 4G/LTE or 5G/NR, that serves the mobile device. The network can use the RAT Type to identify a network entity that maintains information about the mobile device and establish a MONTE subscription configuration with the entity. This reduces unnecessary signaling between network elements and subscriber information management entities that do not maintain information about the mobile device.

### BACKGROUND

Monitoring Event (MONTE) subscriptions enable third-party applications to receive notifications about specific events related to user equipment (UE), such as a mobile device, in telecommunications networks. These events can include changes in a mobile device’s location, roaming status, or reachability. MONTE subscriptions are typically created through a network's exposure function, which acts as an intermediary between external applications and internal network functions.

Telecommunications networks can support multiple radio access technologies (RATs) simultaneously, such as 4G Long-Term Evolution (LTE) and 5G New Radio (NR). In these multi-RAT environments, different network functions may be responsible for managing subscriber information and handling MONTE subscriptions depending on the RAT type used by a particular mobile device. For example, a Home Subscriber Server (HSS) typically manages subscriber data for 4G networks, while a Unified Data Management (UDM) function performs a similar role in 5G networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a diagram illustrating a MONTE Subscription process in a wireless telecommunications network.

FIG. 4 is a diagram illustrating a MONTE subscription process for a telecommunications network.

FIG. 5 is a diagram illustrating a MONTE subscription process for a telecommunications network.

FIG. 6 is a flowchart that illustrates a method of creating a MONTE subscription in a telecommunications network.

FIG. 7 is a flowchart that illustrates a method of requesting a MONTE subscription from a telecommunications network

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

When a telecommunication network uses multiple network functions to store subscriber data, it can lead to inefficient signaling in the network during a MONTE subscription process. In particular, the network may not know which network function is responsible for maintaining the data for the mobile device identified in the MONTE subscription request. This can lead to the network attempting to establish a MONTE subscription with any available network functions that maintain subscriber data.

For example, when the network receives a MONTE request identifying a mobile device, the network may attempt to configure a MONTE subscription with both the HSS and UDM of a network. If only one of these network functions manages the information about the mobile device, the other can respond to the request with an error message. This leads to unnecessary signaling and can distract network operators from more serious error messages being sent by the network.

The disclosed technology relates to improving the efficiency and accuracy of MONTE subscriptions in telecommunications networks that support multiple RATs. Specifically, the technology addresses the issue of unnecessary network traffic and potential system overload that can occur when attempting to create MONTE subscriptions for both 4G and 5G networks without first verifying a mobile device's specific network subscription. The technology enables targeted notifications about a mobile device to be provided to a user based on configured events and the device's network capabilities, while reducing unnecessary subscription attempts.

In one implementation, the network receives a modified MONTE subscription request that includes a RAT type associated with the mobile device. For example, a Network Provider Edge (NPE) function can receive a MONTE subscription, determine a RAT type that is serving the mobile device, and generate a modified MONTE subscription that includes the RAT type. The network can use this information to determine where mobile device's information is maintained and only send the subscription request to the network entities that can fulfill it. This prevents unnecessary signaling by preventing MONTE configuration request being sent to a network function that does not manage information about the mobile device, as well as preventing any error messages that would be generated by the network function. This allows the network to function more efficiently, and prevents harmless errors from distracting network operators from other potentially dangerous errors during operation of the network.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

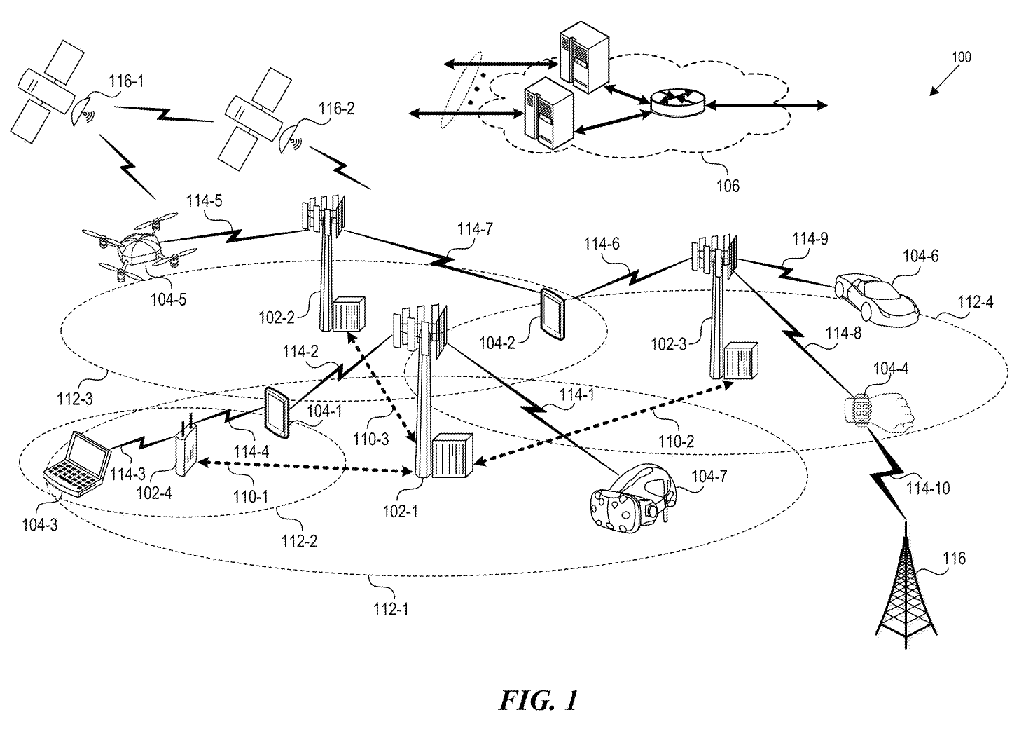

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

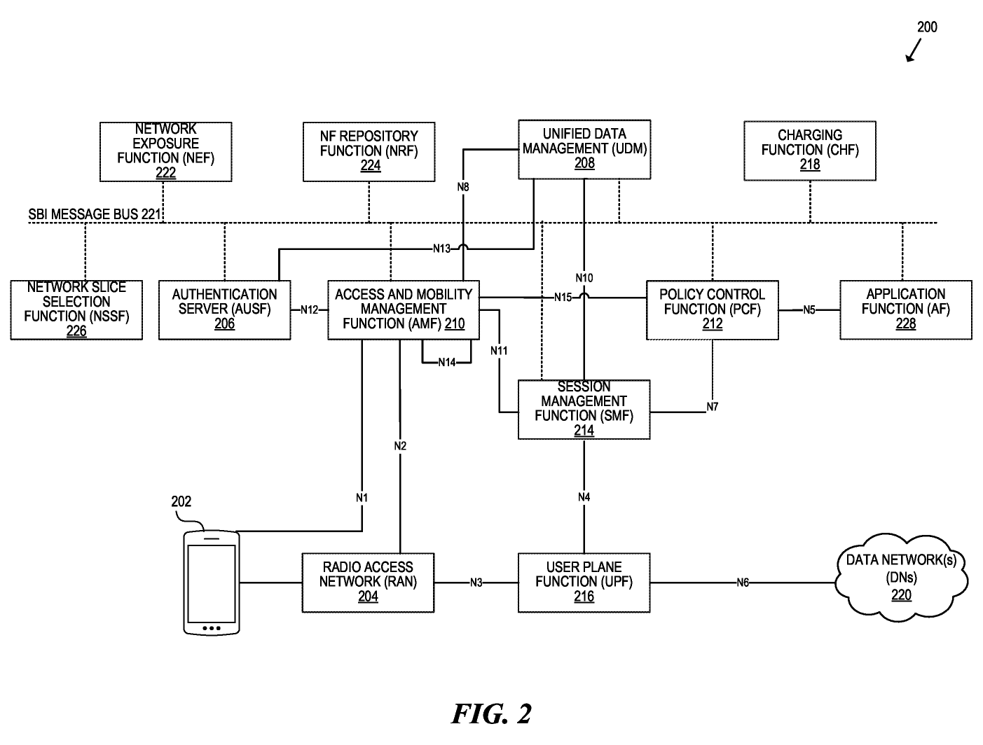

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Monte Flow

Wireless telecommunication networks can support multiple Radio Access Technologies (RATs). For example, a network can include both an Evolved Packet Core (EPC), which supports 4G/LTE connections, and also include a 5G Core (5GC), which supports 5G/NR connections. A network can include a Monitoring Event (MONTE) Subscription process to enable notifications of specific events related to a particular user equipment (UE). The MONTE Subscription process can include the creation of one or more network resources, which can allow a third party to send requests and/or receive information about the UE from the network. The network resource can also be configured to automatically send updates about the UE to a third party.

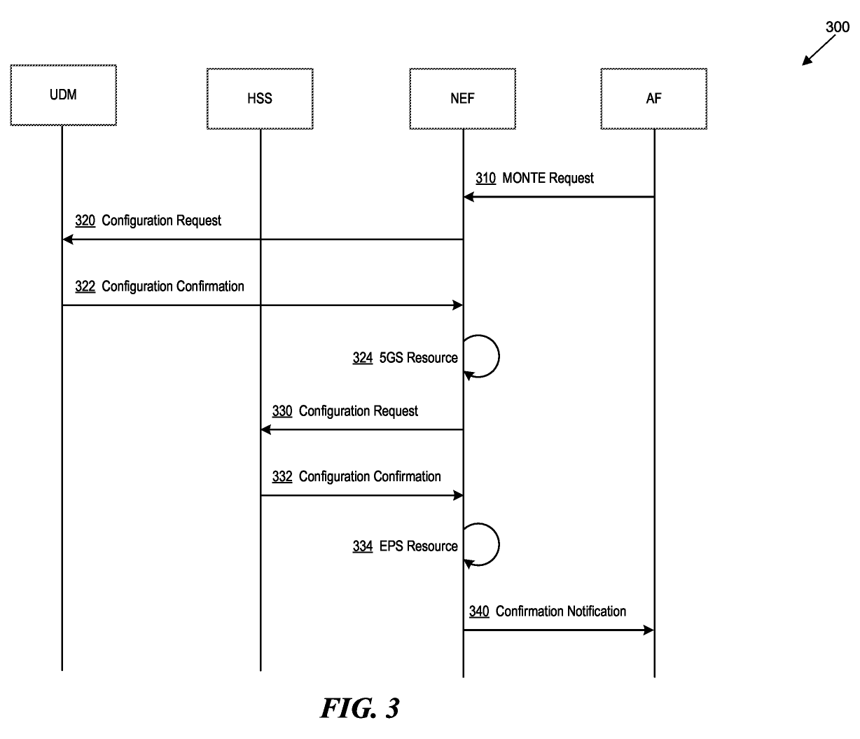

FIG. 3 is a sequence diagram illustrating a MONTE Subscription process 300 in a wireless telecommunications network (“the network”), according to some implementations of the disclosed technology. The sequence diagram illustrates interactions between an Application Function (AF), a Network Exposure Function (NEF), a Unified Data Management (UDM) function, and a Home Subscriber Server (HSS) function during a MONTE subscription process. References to an NEF (for 5G networks) can be used interchangeably with references to a Service Capabilities Exposure Function (SCEF) for 4G networks. The order of the messages illustrated in FIG. 3 between these network elements is not dictated by their order as shown in FIG. 3.

The NEF can receive a MONTE Request 310 sent by a third party, such as from the AF. The NEF can be a function that allows users of the network, such as AFs or other third parties, to request information from a network. The MONTE Request 310 can be configured to request notifications for events, such as when the UE changes location, roaming status, or reachability.

A UE connected to the network can be configured to operate using one or more RATs. For example, the UE can operate using 4G, 5G, or a combination thereof (e.g., Standalone (SA) or Non-Standalone (NSA) dual-connectivity). Thus, the HSS and/or UDM can contain incomplete information about a UE and/or no information about a UE, depending on the services that the HSS and/or UDM are configured to provide for the UE.

The NEF can send a 5G Subscription Configuration Request 320 to the UDM. The 5G Subscription Configuration Request 320 conform to a format expected by the UDM, such as HTTPS POST request message. If the UDM contains and/or maintains the UE information requested by the 5G Subscription Configuration Request 320, the UDM can process the request and respond with a 5G Subscription Configuration Confirmation 322. The 5G Subscription Configuration Confirmation 322 can conform to a format expected from the UDM, such as a "201 Created" response message. The NEF can create a 5GS Resource 324 for the MONTE Subscription, which can allow the AF to request and/or receive information associated with the MONTE Subscription. However, if the UDM does not contain and/or maintain the UE information requested by the 5G Subscription Configuration Request 320, the UDM can respond with an error message. For example, if the UE is not provisioned for 5G services and/or the UDM does not store information about the UE, the UDM can respond with a "403 Error" response message.

The NEF can send a 4G Subscription Configuration Request 330 to the HSS. The 4G Subscription Configuration Request 330 can conform to a format expected by the HSS, such as a Diameter Configuration Information Request (CIR). If the HSS contains and/or maintains the UE information requested by the 4G Subscription Configuration Request 330, the HSS can process the request and respond with a 4G Subscription Configuration Confirmation 332. The 4G Subscription Configuration Confirmation 332 can conform to a format expected from the HSS, such as a Diameter Configuration Information Answer (CIA). The NEF can create an EPS Resource 334 for the MONTE Subscription, which can allow the AF to request and/or receive information associated with the MONTE subscription. However, if the HSS does not contain and/or maintain the UE information requested by the 4G Subscription Configuration Request 330, the HSS can respond with an error message. For example, if the UE is not provisioned for 4G services and/or the HSS does not store information about the UE, then the HSS can respond with a Diameter_Unknown_EPS_Subscription CIA.

An NEF resource, such as the 5GS Resource 324 and/or the EPS Resource 334, can include an interface or protocol configured to receive messages. For example, the resource can be associated with a Uniform Resource Identifier (URI) and/or a Uniform Resource Locator (URL) to allow a third party, such as the AF, to send requests through the internet. The resource can use an API, such as a RESTful API, that is configured to receive messages, such as HTTP messages, and return information related to the MONTE Subscription. The resource can also be configured to automatically send messages to, for example, a callback URL, in response to events, such as an update in the information about the UE.

The NEF can send a Subscription Confirmation Notification 340 to the AF, indicating the successful creation of the MONTE Subscription. The Subscription Confirmation Notification 340 can contain information about the created resource(s). For example, the Subscription Confirmation Notification 340 can contain a URI and/or URL associated with the created resource(s).

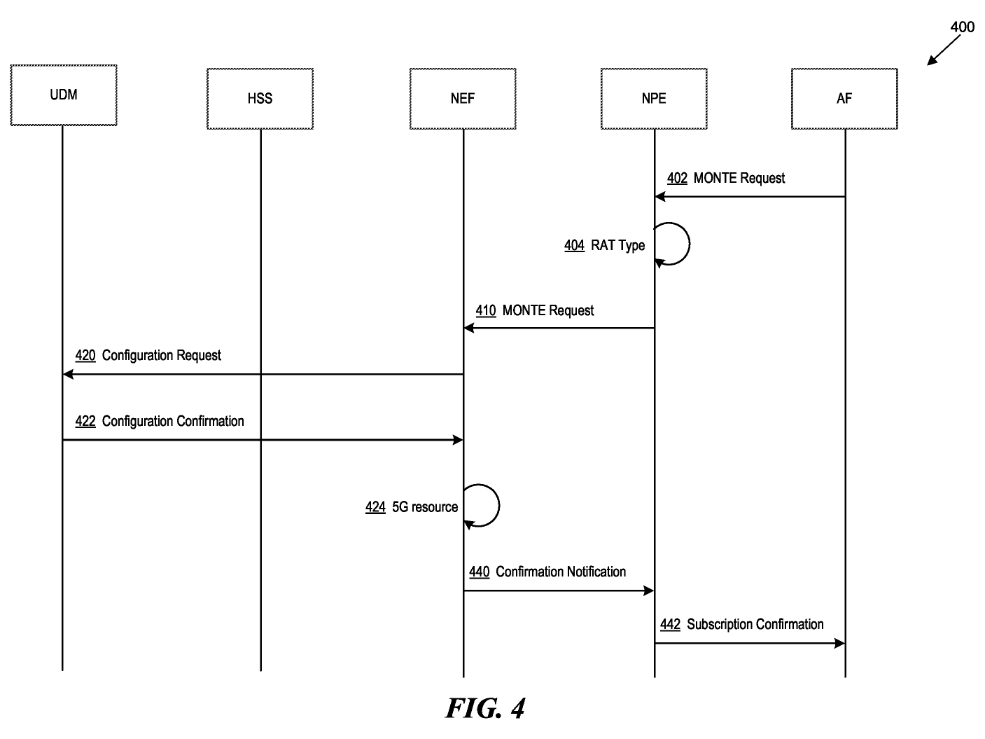

FIG. 4 is a sequence diagram illustrating a MONTE subscription process 400 for the network, in accordance with some implementations of the disclosed technology. The AF can send a Preliminary MONTE Request 402 to another entity, such as a Network Provider Edge (NPE) node. The NPE can add a RAT Type 404 to the Preliminary MONTE Request 402 to generate a Modified MONTE Request 410. The Preliminary MONTE Request 402 and/or the Modified MONTE Request 410 can identify a UE that is provisioned to operate using the RAT Type 404, such that the RAT Type 404 indicates a service type of the UE. In some implementations, the NPE can receive the RAT Type 404 from the network, such as by querying an NEF, a Policy and Charging Rules Function (PCRF), Policy Control Function (PCF), an Access and Mobility Management Function (AMF), or a Session Management Function (SMF). In some implementations, the NPE receives the RAT Type 404 from another source, such as the AF. For example, the NPE can receive the Preliminary MONTE Request 402 and the RAT Type 404 separately and can generate the Modified MONTE Request 410 using the RAT Type 404 and the Preliminary MONTE Request 402. The RAT Type 404 can identify a 4G network type, such as LTE, EPC, and/or EPS, and/or can identify a 5G network type, such as NR, 5GC, and/or 5GS. In some implementations, the RAT Type 404 can identify a 6G network type, or other future network type. In some implementations, the AF performs the functions shown in FIG. 4 to be performed by the NPE. For example, the AF can receive a RAT Type 404 and/or generate a Modified MONTE Request 410 using the RAT Type 404.

The NPE (and/or the AF) can send the Modified MONTE Request 410 to the NEF. If the RAT Type identifies a 5G network type, then the NEF can send a 5G Subscription Configuration Request 420 to the UDM, and the UDM can respond with a 5G Subscription Configuration Confirmation 422. The NEF can create a MONTE Subscription Resource 424 (e.g., a 5GS Resource) and send a Subscription Confirmation Notification 440 to the NPE and/or AF. Additionally, or alternatively, the NPE can send a Successful Subscription Confirmation 442 to the AF, which can contain information from the Subscription Confirmation Notification 440.

In some implementations, the NEF receives (e.g., from the NPE and/or AF) a MONTE Request does not contain the RAT Type 404, and the NEF is configured to determine the RAT Type 404 of the UE identified in the MONTE Request. The NEF can use the RAT Type 404 and the MONTE Request to generate the Modified MONTE Request 410. Alternately, or additionally, the NEF can use the RAT Type 404 and the MONTE Request separately, such that if the RAT Type 404 identifies a 5G network type, then the NEF can send the 5G Subscription Configuration Request 420 to the UDM, requesting the MONTE Subscription configuration identified in the MONTE Subscription Request.

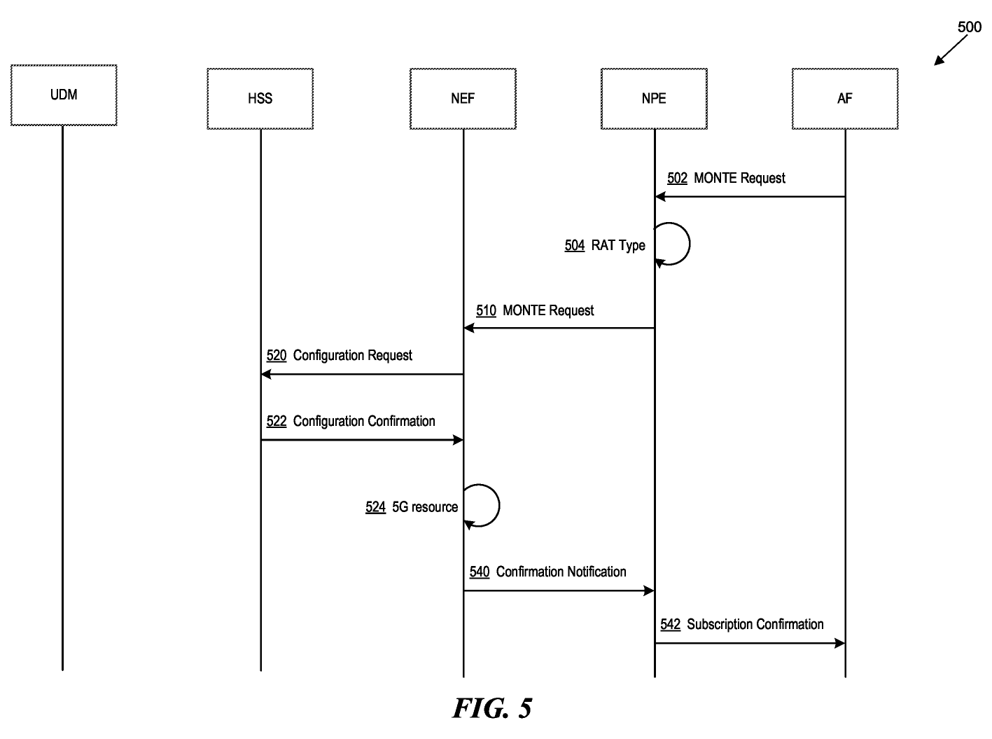

FIG. 5 is a sequence diagram illustrating a MONTE subscription process 500 for the network, in accordance with some implementations of the disclosed technology. The AF can send a Preliminary MONTE Request 502 to another entity, such as an NPE node. The NPE can add a RAT Type 504 to the Preliminary MONTE Request 502 to generate a Modified MONTE Request 510. The Preliminary MONTE Request 502 and/or the Modified MONTE Request 510 can identify a UE that is provisioned to operate using the RAT Type 504, such that the RAT Type 504 indicates a service type of the UE. In some implementations, the NPE can receive the RAT Type 504 from the network, such as by querying an NEF, PCRF, PCF, AMF, or SMF. In some implementations, the NPE receives the RAT Type 504 from another source, such as the AF. For example, the NPE can receive the Preliminary MONTE Request 502 and the RAT Type 504 separately and can generate the Modified MONTE Request 510 using the RAT Type 504 and the Preliminary MONTE Request 502. The RAT Type 504 can identify a 4G network type, such as LTE, EPC, and/or EPS, and/or can identify a 5G network type, such as NR, 5GC, and/or 5GS. In some implementations, the RAT Type 404 can identify a 6G network type, or other future network type. In some implementations, the AF performs the functions shown in FIG. 5 to be performed by the NPE. For example, the AF can receive a RAT Type 504 and/or generate a Modified MONTE Request 510 using the RAT Type 504.

The NPE (and/or the AF) can send the Modified MONTE Request 510 to the NEF. If the RAT Type identifies a 4G network type, then the NEF can send a 4G Subscription Configuration Request 520 to the HSS, and the HSS can respond with a 4G Subscription Configuration Confirmation 522. The NEF can create a MONTE Subscription Resource 524 (e.g., a EPS Resource) and send a Subscription Confirmation Notification 540 to the NPE and/or AF. Additionally, or alternatively, the NPE can send a Successful Subscription Confirmation 542 to the AF, which can contain information from the Subscription Confirmation Notification 540.

In some implementations, the NEF receives (e.g., from the NPE and/or AF) a MONTE Request does not contain the RAT Type 504, and the NEF is configured to determine the RAT Type 504 of the UE identified in the MONTE Request. The NEF can use the RAT Type 504 and the MONTE Request to generate the Modified MONTE Request 510. Alternately, or additionally, the NEF can use the RAT Type 504 and the MONTE Request separately, such that if the RAT Type 504 identifies a 4G network type, then the NEF can send the 4G Subscription Configuration Request 520 to the HSS, requesting the MONTE Subscription configuration identified in the MONTE Subscription Request.

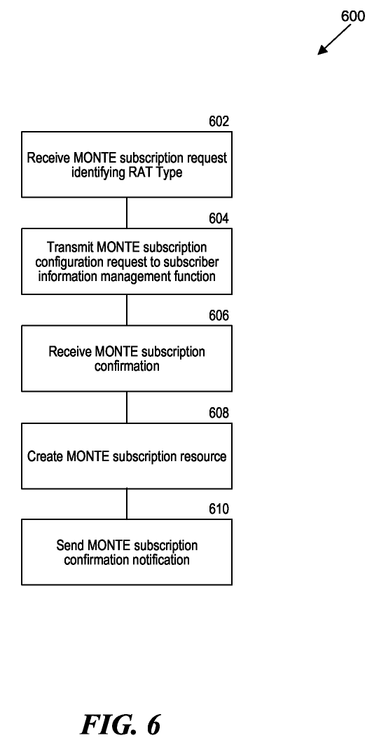

FIG. 6 is a flowchart that illustrates a method 600 of creating a MONTE subscription in a telecommunications network (“the network”) in accordance with the present disclosure. The method can be performed one or more entities connected to and/or integrated with the network, such as an NEF, NPE, and/or another network element, AF, and/or other third-party entity.

At 602, the network can receive (e.g., from an AF, from an NPE, and/or at an exposure function of the network, such as an NEF) a MONTE subscription request that identifies a RAT Type. The MONTE subscription request can identify a UE (e.g., where the UE is provisioned and/or served by the network using the RAT Type, and/or the RAT Type indicates a service type for the UE). The RAT Type can include an indication of 4G service (e.g., indicating LTE and/or EPS service), 5G service (e.g., indicating NR and/or 5GS service), 6G service, Non-Terrestrial Network (NTN) service, any other RAT Type, or any combination thereof. The MONTE subscription request can include indications of information and/or events that can be reported by the network according to the resulting MONTE subscription. For example, the MONTE subscription request can be configured to request notification of events pertaining to at least one of: a location of the UE, a roaming status of the UE, or UE reachability.

In some implementations, the MONTE subscription request can be generated by adding a RAT Type to a preliminary MONTE subscription request. In some implementations, the network can receive a MONTE subscription request that does not have a RAT Type and determine the RAT Type associated with the UE. For instance, an exposure function of the network (e.g., an NEF) can query the telecommunications network (e.g., an NEF, a PCRF, a PCF, an AMF, and/or an SMF of the network) to determine a RAT Type associated with the UE. The exposure function can modify the MONTE subscription request to include the RAT Type. Alternatively, or additionally, the exposure function can perform the MONTE subscription using the RAT Type information in lieu of adding the RAT Type to the MONTE subscription request and/or determining the RAT Type from the MONTE subscription request.

In some implementations, the RAT Type is added to a preliminary MONTE subscription request before the request is received by the network. For example, the MONTE subscription request can be generated by a third party, such as an AF, and/or an NPE, which can receive a preliminary MONTE request that does not contain a RAT Type and generate the MONTE subscription request at least in part by adding the RAT Type to the preliminary MONTE subscription request. This can be done, for instance, by requesting (e.g., by an NPE) the RAT Type of the UE from the network. In some implementations, the network (e.g., an exposure function, such as an NEF) receives a MONTE subscription request from an NPE at a first time period, where the NPE receives a preliminary MONTE subscription (e.g., from an AF) at a second time period prior to the first time period (e.g., a second time period that is before the first time period), where the MONTE subscription request is a modified version of the preliminary MONTE subscription request and is generated at least in part by adding the RAT Type to the preliminary MONTE subscription request.

At 604, the network (e.g., at an exposure function, such as an NEF) can transmit a MONTE subscription configuration request to a subscriber information management function of the network. The subscriber information management function can store and/or maintain user information, such as subscriber data, pertaining to the UE. The subscriber information management function can correspond to the RAT Type. In some implementations, the network transmits the MONTE subscription configuration request to a UDM of the network, such as when the RAT Type indicates a 5G service. The MONTE subscription configuration request can conform to a format expected by the UDM, such as HTTPS POST request message. In some implementations, the network transmits the MONTE subscription configuration request to an HSS of the network, such as when the RAT Type indicates a 4G service. The MONTE subscription configuration request can conform to a format expected by the HSS, such as a Diameter CIR. In some implementations, the network transmits the MONTE subscription configuration request to a different subscriber information management function, such as when the RAT Type indicates a 6G service, or another type of service. In some implementations the network determines, based on RAT Type, a subscriber information management function that corresponds to the RAT Type and sends a MONTE subscription configuration request to the determined subscriber information management function.

At 606, the network (e.g., an NEF) can receive a MONTE subscription confirmation from the subscriber information management function of the network. This can be received from a UDM, such as when the RAT Type indicates a 5G service, and can conform to a format expected for UDM responses, such as a “201 Created” response message. The subscription confirmation can be received from an HSS, such as when the RAT Type indicates a 4G service, and can conform to a format expected for HSS responses, such as a Diameter CIA.

At 608, the network can create (e.g., at an exposure function of the network, such as an NEF), a MONTE subscription resource. The MONTE subscription resource can correspond to the RAT Type, such as a 5GS MONTE subscription corresponding to a 5G RAT Type, and/or an EPS MONTE subscription corresponding to a 4G RAT Type. The MONTE subscription resource can be a network resource, can have a URI and/or URL, and can be reachable via the internet (e.g., the resource can be configured to implement a RESTful API, such as HTTP).

In some implementations, the MONTE subscription request can indicate multiple RAT Types (such as when the UE is provisioned for dual-connectivity) and send MONTE subscription configuration requests to multiple subscriber information management functions. For example, the MONTE subscription request can indicate 5G and 6G, and the network can send MONTE subscription configuration requests to the UDM and/or a 6G subscriber information management function, while not sending a MONTE subscription confirmation request to the HSS. In another example, the MONTE subscription request can indicate 4G and 5G, and the network can send MONTE subscription configuration request to the HSS and the UDM. The corresponding subscriber information management function(s) can each send a MONTE subscription confirmation, and the network can create corresponding MONTE subscription resources.

At 610, the network can send a MONTE subscription confirmation notification. For example, the network (e.g., an NEF) can send a MONTE subscription confirmation notification to an AF, such as an entity that supplied the MONTE subscription request.

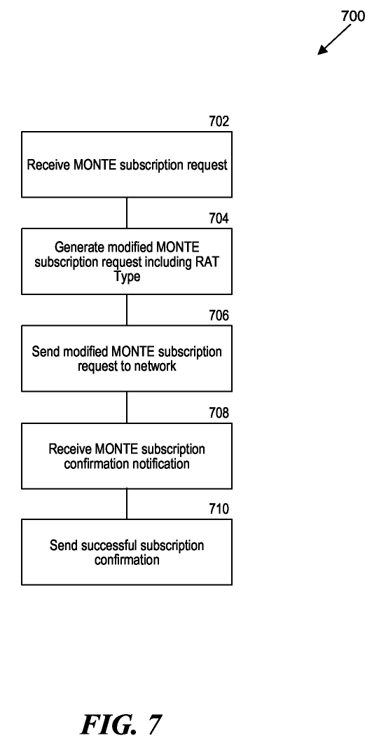

FIG. 7 is a flowchart that illustrates a method 700 of requesting a MONTE subscription from the network, in accordance with the present disclosure. The method can be performed one or more entities connected to and/or integrated with the network, such as an NEF, NPE, and/or another network element, AF, and/or other third-party entity.

At 702, a communication node (e.g., an exposure function of the network, such as an NEF, or an NPE, such as a third party) can receive a MONTE subscription request for the network. The MONTE subscription request can be a preliminary MONTE subscription request and lack a RAT Type. The preliminary MONTE request can be received from a separate entity (e.g., a third party, such as an AF). The preliminary MONTE subscription request can indicate a UE that is subscribed to the network to receive services via a certain RAT Type. In some implementations, the UE is subscribed to received multiple RAT Types. The preliminary MONTE subscription request can include indications of information and/or events that can be reported by the network according to the resulting MONTE subscription. For example, the MONTE subscription request can be configured to request notification of events pertaining to at least one of: a location of the UE, a roaming status of the UE, or UE reachability.

At 704, the communication node can generate a modified MONTE subscription request that comprises an indication of the RAT Type of the UE. In some implementations, the MONTE subscription request is associated with the RAT Type (e.g., a third party sends the communication node the preliminary MONTE request and the RAT Type separately). In some implementations, the communication node can request information identifying the RAT Type from the network. For example, the communication node can query an NEF of the network, a PCRF, a PCF, an AMF, and/or a SMF. The RAT Type can include an indication of 4G service (e.g., indicating LTE and/or EPS service), 5G service (e.g., indicating NR and/or 5GS service), 6G service, NTN service, any other RAT Type, or any combination thereof.

At 706, the communication node can send the modified MONTE subscription request to the network. For instance, the communication node can send the modified MONTE subscription to an NEF of the network.

At 708, the communication node can receive (e.g., from an NEF) a subscription confirmation notification. In some implementations, the successful subscription confirmation can be generated by the methods of the present disclosure (e.g., the method described with respect to FIG. 6.). For example, the successful subscription confirmation can be generated at least in part by sending (e.g., by an NEF) a MONTE subscription configuration request to a subscriber information management function of the telecommunications network corresponding to the RAT Type and generating the successful subscription confirmation in response to receiving (e.g., by the NEF) a subscription confirmation from the subscriber information management function. In some implementations, the subscriber information management function is a UDM of the network, such as when the RAT Type indicates a 5G service. In some implementations, the subscriber information management function is an HSS of the network, such as when the RAT Type indicates a 4G service.

At 710, the communication node can send a successful subscription confirmation to another entity, such as an AF (e.g., the AF that sent the preliminary MONTE subscription request).

In some implementations, the successful subscription confirmation is generated at least in part by sending (e.g., by an NEF) a MONTE subscription configuration request to a subscriber information management function of the telecommunications network, the subscriber information management function corresponding to the RAT Type, and generating, in response to receiving a subscription confirmation from the subscriber information management function, the successful subscription confirmation.

In some implementations, an entity (such as the network, a network function, or another third-party entity) can receive a MONTE subscription request for the telecommunications network that does not include a RAT Type (e.g., a preliminary MONTE subscription request). The preliminary MONTE request can be received, for example, from an AF or other third party. The preliminary MONTE subscription request can indicate a UE that is subscribed to the telecommunications network to receive services via one or more RAT Types. The entity can generate a modified MONTE subscription request that comprises an indication of the RAT Type of the UE. The entity can sent to the telecommunications network (e.g., a NEF of the telecommunications network), the modified MONTE subscription, which includes the RAT Type.

### Computer System

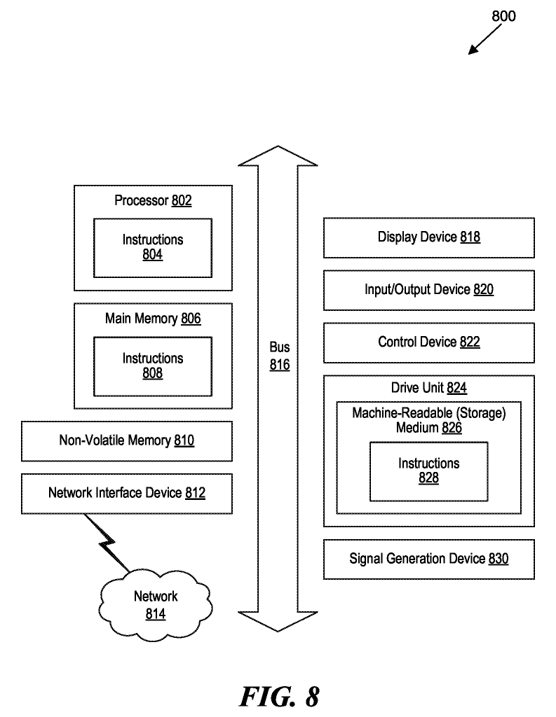

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. At least one non-transitory, computer-readable storage medium comprising instructions recorded thereon, wherein the instructions, when executed by at least one data processor of a system in a telecommunications network, cause the system to:
receive, from an application function (AF) and at a network exposure function (NEF), a Monitoring Event (MONTE) subscription request,
wherein the MONTE subscription request identifies: (1) a user equipment, and (2) a Radio Access Technology (RAT) Type,
wherein the RAT Type indicates a service type of the user equipment, and
wherein the RAT Type indicates 4G network configuration or 5G network configuration;
transmit a MONTE subscription configuration request to a subscriber information management function of the telecommunications network; and
create, at the NEF, a MONTE subscription resource corresponding to the RAT Type.

2. The at least one non-transitory, computer-readable storage medium of claim 1, wherein when the RAT Type indicates 4G network configuration:
the subscriber information management function comprises a Home Subscriber Server (HSS) function; and
the MONTE subscription corresponding to the RAT Type is an Evolved Packet System (EPS) subscription.

3. The at least one non-transitory, computer-readable storage medium of claim 1, wherein when the RAT Type indicates 5G network configuration:
the subscriber information management function comprises a Unified Data Management (UDM) function; and
the MONTE subscription corresponding to the RAT Type is a 5G System (5GS) subscription.

4. The at least one non-transitory, computer-readable storage medium of claim 1, wherein receiving the MONTE subscription request from the AF further comprises:
receiving, from a Network Provider Edge (NPE) function, a MONTE subscription request at a first time period,
wherein the NPE receives a preliminary MONTE subscription request from the AF at a second time period that is before the first time period,
wherein the MONTE subscription request is a modified version of the preliminary MONTE subscription request, and
wherein the MONTE subscription request is generated at least in part by adding the RAT Type to the preliminary MONTE subscription request.

5. The at least one non-transitory, computer-readable storage medium of claim 1, wherein the MONTE subscription request is configured to request notifications of events pertaining to at least one of: a location of the user equipment, a roaming status of the user equipment, or user equipment reachability.

6. The at least one non-transitory, computer-readable storage medium of claim 1, further comprising instructions to:
send a subscription confirmation notification to the AF.

7. A system comprising:
at least one hardware processor; and
at least one non-transitory memory storing instructions, which, when executed by the at least one hardware processor, cause the system to:
receive, from an Application Function (AF), a preliminary Monitoring Event (MONTE) subscription request for a telecommunications network,
wherein the preliminary MONTE subscription request indicates a User Equipment (UE),
wherein the UE is subscribed to the telecommunications network to receive services via a certain Radio Access Technology (RAT) Type;
generate a modified MONTE subscription request,
wherein the modified MONTE subscription request comprises an indication of the RAT Type of the UE;
send, to a Network Exposure Function (NEF) of the telecommunications network, the modified MONTE subscription; and
receive, from the NEF, a subscription confirmation notification, wherein the subscription confirmation notification is generated at least in part by:
sending, by the NEF, a MONTE subscription configuration request to a subscriber information management function of the telecommunications network, the subscriber information management function corresponding to the RAT Type, and
generating, in response to receiving a subscription confirmation from the subscriber information management function, the subscription confirmation notification.

8. The system of claim 7,
wherein the RAT Type indicates 4G, and
wherein the subscriber information management function is a Home Subscriber Server (HSS) function.

9. The system of claim 7,
wherein the RAT Type indicates 5G, and
wherein the subscriber information management function is a Unified Data Management (UDM) function.

10. The system of claim 7, wherein generating the modified MONTE subscription request comprises:
requesting, from the telecommunications network, information identifying the RAT Type of the UE.

11. The system of claim 7, wherein the preliminary MONTE subscription request is configured to request notifications of events pertaining to at least one of: a location of the UE, a roaming status of the UE, or UE reachability.

12. The system of claim 7, wherein instructions stored on the memory further cause the system to send a successful subscription confirmation to the AF.

13. A computer-implemented method comprising:
receiving a Monitoring Event (MONTE) subscription request for a telecommunications network,
wherein the MONTE subscription request indicates a User Equipment (UE),
wherein the UE is subscribed with the telecommunications network to receive services via a Radio Access Technology (RAT) Type;
determining, based on the RAT Type, a subscriber information management function of the telecommunications network,
wherein the subscriber information management function corresponds to the RAT Type;
sending, to the subscriber information management function of the telecommunications network that corresponds to the RAT Type, a MONTE subscription configuration request; and
creating, at an exposure function of the telecommunications network, a MONTE subscription resource.

14. The computer-implemented method of claim 13,
wherein the RAT Type indicates 4G, and
wherein the subscriber information management function comprises a Home Subscriber Server (HSS) function of the telecommunications network.

15. The computer-implemented method of claim 13,
wherein the RAT Type indicates 5G, and
wherein the subscriber information management function comprises a Unified Data Management (UDM) function of the telecommunications network.

16. The computer-implemented method of claim 13, wherein the RAT Type indicates 6G.

17. The computer-implemented method of claim 13, wherein the MONTE subscription request is received from an Application Function (AF).

18. The computer-implemented method of claim 13, wherein receiving the MONTE subscription request comprises:
receiving, from a Network Provider Edge (NPE) function, the MONTE subscription request,
wherein the MONTE subscription request is generated by the NPE,
wherein the MONTE subscription request is generated at least in part by:
receiving, at the NPE and from an Application Function (AF), a preliminary MONTE subscription request, and
generating the MONTE subscription request at least in part by adding the RAT Type to the preliminary MONTE subscription request.

19. The computer-implemented method of claim 18, wherein generating the MONTE subscription request at least in part by adding the RAT Type to the preliminary MONTE subscription request comprises:
requesting, from the telecommunications network, the RAT Type of the UE.

20. The computer-implemented method of claim 13, wherein the MONTE subscription request is configured to request notifications of events pertaining to at least one of: a location of the UE, a roaming status of the UE, or UE reachability.
